(19) United States
(12) Patent Application Publication
(10) Pub. No.: US 2008/0152031 A1
(43) Pub. Date: Jun. 26, 2008

(54) Uplink scheduling method and apparatus in communication system

(75) Inventors: Jae-Kil Lee, Gwanak-gu (KR); Sung-Wook Park, Scongnam-si (KR); Seong-Joon Jeon, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD, Suwon-si (KR)

(21) Appl. No.: 12/001,788

(22) Filed: Dec. 11, 2007

(30) Foreign Application Priority Data
Dec. 11, 2006 (KR) 2006-125729

(51) Int. Cl. H04K 1/10

(52) U.S. Cl. 375/260

(57) ABSTRACT

Provided is an uplink scheduling method and apparatus of a Base Station, in which total packet transmission time can be reduced by reducing the time required for a Subscriber Station to request a frequency band for packet transmission to the BS through a series of contention procedures and to be allocated to the frequency band. Therefore, even an SS that is not allocated a frequency band in an UpLink-MAP can immediately transmit a frequency band allocation request without overhead, thereby reducing initial delay time.

### PRIORITY

This application claims priority under 35 U.S.C. § 119(a) to a Korean Patent Application filed in the Korean Intellectual Property Office on Dec. 11, 2006 and assigned Serial No. 2006-125729, the entire disclosure of which is incorporated herein by reference.

### BACKGROUND OF THE INVENTION

1. Field of the Invention

The present invention relates generally to a scheduler of a Base Station (BS), and in particular, to a scheduler of a BS in an Orthogonal Frequency Division Multiplexing (OFDM) system, an Orthogonal Frequency Division Multiple Access (OFDMA) system, an IEEE 802.16 system, or an IEEE 802.16-based Wireless Broadband (WiBro) system.

2. Description of the Related Art

A function of a scheduler of a Base Station (BS), which will hereinafter be referred to as a BS scheduler, can be roughly divided into uplink scheduling and downlink scheduling. The present invention particularly relates to an uplink scheduling process for allocating a radio resource to each Subscriber Station (SS) to allow the SS to upload data.

A Wireless Broadband (WiBro) standard and the IEEE 802.16 standard do not describe in detail how to implement a BS scheduler. A currently widely used uplink scheduling scheme is a user-based proportional fair scheduling method for guaranteeing Quality of Service (QoS) and fairness.

In an IEEE 802.16 system, for data upload, each SS has to first transmit a radio resource request indicating the required amount of radio resource to a BS. The BS collects a frequency band allocation request of each SS and generates MAP information that the BS periodically broadcasts to each SS through uplink scheduling. The SS analyzes the MAP information and thus can upload data only on a radio resource of a frequency band allocated to the SS itself.

In an IEEE 802.16 system, in order to upload data to a BS, each SS transmits a frequency band allocation request for requesting a frequency band for data transmission to the BS using a series of contention procedures. Once the SS is allocated the frequency band, it transmits the frequency band allocation request for data transmission to the BS again. When the BS allocates the requested frequency band to the SS, the SS can upload data in the allocated frequency band.

When a frame interval is 5 msec and the time required for a BS to receive and process a frequency band allocation request of an SS is 4 frames in an IEEE 802.16 system, the time required for the SS to be allocated a frequency band for data upload is about 30 msec, apart from the time required for frequency band request contention. Thus, considering the time required for the SS to be allocated a frequency band for requesting a frequency band for data transmission through a series of contention procedures and the time required for the SS to transmit a frequency band allocation request to the BS and to be allocated the frequency band for data transmission, the time required for the SS to transmit data to the BS is more than 60 msec in the conventional system. Such a long time originates from a feature of an IEEE 802.16 system in which each SS can upload data only after transmitting a frequency band allocation request for the data upload to the BS and being allocated a frequency band.

When an SS is currently transmitting data, it may transmit a frequency band allocation request to a BS by piggybacking the frequency band allocation request on the data or exclusively using a previously allocated frequency band. However, in other cases, overhead is generated due to the frequency band allocation request because the SS has not yet been allocated a frequency band. In particular, for communication where data transmissions do not occur consecutively, time delay for an initial frequency band allocation request is inevitable during an interval where no data transmission occurs.

### SUMMARY OF THE INVENTION

An aspect of the present invention is to solve at least the above problems and/or disadvantages and to provide at least the advantages described below. Accordingly, an aspect of the present invention is to provide a method and apparatus for reducing total data transmission time by reducing the time required for a Subscriber Station (SS) to request and to be allocated a frequency band for data transmission to a Base Station (BS).

According to one aspect of the present invention, there is provided an uplink scheduling method for a BS in a communication system where each SS is allocated a frequency band by the BS to transmit data. The uplink scheduling method includes collecting frequency band allocation requests from first SSs and allocating frequency bands to the first SSs that transmit the frequency band allocation requests to the BS according to the collection result, checking if there remain frequency bands that are not allocated to the first SSs from among total frequency bands, when there remain the non-allocated frequency bands, allocating at least some of the remaining frequency bands to second SSs that do not transmit the frequency band allocation requests to the BS, and transmitting information of the frequency band allocation to the first SSs and the second SSs.

According to another aspect of the present invention, there is provided a BS device for performing uplink scheduling in a communication system where each SS is allocated a frequency band by a BS to transmit data. The BS device includes a frequency band request collector for collecting frequency band allocation requests from first SSs, a first frequency band allocator for allocating frequency bands to the first SSs that transmit the frequency band allocation requests to the BS according to the collection result of the frequency band request collector, a second frequency band allocator for allocating at least some of non-allocated frequency bands, which remain after the frequency band allocation, to second SSs that do not transmit the frequency band allocation requests to the BS, and a MAP generator for generating information of the frequency band allocation of the first frequency band allocator and information of the frequency band allocation of the second frequency band allocator as a MAP and transmitting the generated MAP to the first SSs and the second SSs.

### BRIEF DESCRIPTION OF THE DRAWINGS

The above and other features and advantages of the present invention will become more apparent from the following detailed description when taken in conjunction with the accompanying drawings, in which:

FIGS. 1A and 1B illustrate a structure of a general Base Station scheduler;

FIG. 2 illustrates a structure of an uplink scheduler of a Base Station scheduler according to the present invention; and

FIG. 3 is a flowchart illustrating an operation of the uplink scheduler according to the present invention.

### DETAILED DESCRIPTION OF THE EXEMPLARY EMBODIMENT

The matters defined in the description below such as a detailed construction and elements are provided to assist in a comprehensive understanding of an exemplary embodiment of the invention. Those of ordinary skill in the art will recognize that various changes and modifications of the embodiment described herein can be made without departing from the scope and spirit of the invention. Also, descriptions of well-known functions and constructions are omitted for clarity and conciseness. Terms used herein are defined based on functions in the present invention and may vary according to users, operators' intention or usual practices. Therefore, the definition of the terms should be made based on contents throughout the specification.

According to the present invention, in an Orthogonal Frequency Division Multiplexing (OFDM) system or an Orthogonal Frequency Division Multiple Access (OFDMA) system, during uplink scheduling, a scheduler of a Base Station (BS), which will hereinafter be referred to as a BS scheduler, arbitrarily allocates a frequency band even to a Subscriber Station (SS) that does not transmits a frequency band allocation request to the BS, thereby reducing the time required for the SS to request a frequency band for data transmission through a series of contention procedures and to be allocated the frequency band for data transmission.

Hereinafter, an uplink scheduling method according to the present invention will be described with reference to the accompanying drawings.

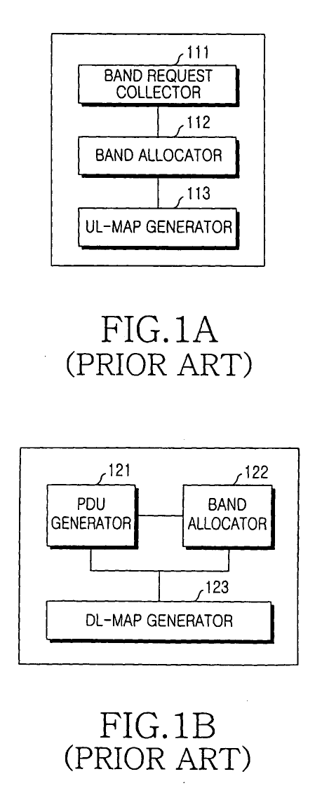

FIG. 1A illustrates a structure of an uplink scheduler of a general BS scheduler.

Referring to FIG. 1A, the uplink scheduler includes a frequency band request collector 111, a frequency band allocator 112, and an UpLink (UL)-MAP generator 113.

The frequency band request collector 111 collects frequency band allocation requests from SSs. The frequency band allocator 112 allocates frequency bands to the SSs based on the frequency band allocation requests collected by the frequency band request collector 111. The UL-MAP generator 113 generates an uplink frequency band allocation MAP (UL-MAP) according to the frequency band allocation of the frequency band allocator 112 and transmits the generated UL-MAP to the SSs.

FIG. 1B illustrates a structure of a downlink scheduler of a general BS scheduler.

Referring to FIG. 1B, the downlink scheduler includes a Protocol Data Unit (PDU) generator 121, a frequency band allocator 122, and a DownLink (DL)-MAP generator 123.

The PDU generator 121 divides a Service Data Unit (SDU) and adds Protocol Control Information (PCI) to each of the divided SDUs, thereby generating Protocol Data Units (PDUs).

The frequency band allocator 122 allocates a frequency band for each SS in order to transmit the PDU generated by the PDU generator 121 to each SS. The DL-MAP generator 123 generates a downlink frequency band allocation MAP (DL-MAP) according to the frequency band allocation of the frequency band allocator 122 and transmits the generated DL-MAP to each SS.

In a system having the scheduler illustrated in FIGS. 1A and 1B, an SS has to transmit a frequency band allocation request to a BS in order to upload data. When the SS is continuously transmitting data to the BS, it may transmit a frequency band allocation request to the BS by exclusively using a frequency band that has already been allocated for piggyback or data transmission. However, when the SS has not yet been allocated a frequency band, overhead is generated due to a frequency band allocation request for requesting a frequency band for data upload.

Therefore, the present invention suggests a method for reducing overhead generated due to a frequency band allocation request for an uplink operation.

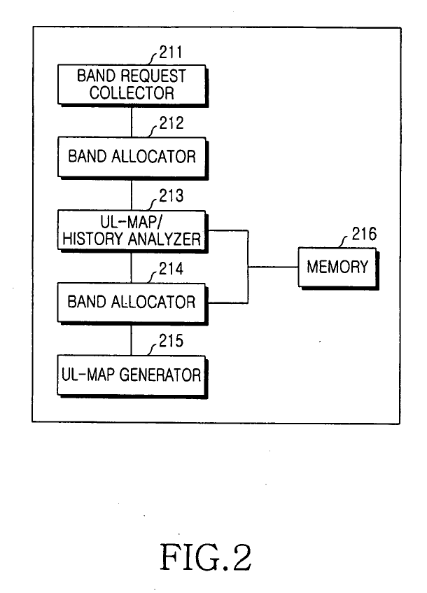

FIG. 2 illustrates a structure of an uplink scheduler of a BS scheduler according to an exemplary embodiment of the present invention. A downlink scheduler of the BS scheduler is not directly associated with the present invention and thus will not be described and not be shown in the drawings.

Referring to FIG. 2, the uplink scheduler according to an exemplary embodiment of the present invention includes a band request collector 211, a band allocator 212, a UL-MAP/history analyzer 213, a band allocator 214, a UL-MAP generator 215, and a memory 216.

The band request collector 211 collects frequency band allocation requests from SSs. The band allocator 212 allocates frequency bands to SSs based on the frequency band allocation requests collected by the band request collector 211. The UL-MAP/history analyzer 213 analyzes a history including information about frequency bands remaining after the frequency band allocation, information about recent frequency band allocation to each SS, and the like in a current UL-MAP. The band allocator 214 arbitrarily allocates the remaining frequency bands to SSs that do not request frequency band allocation, based on the analysis result of the UL-MAP/history analyzer 213 and a predetermined priority order. The UL-MAP generator 215 generates an UL-MAP according to the frequency band allocation of the band allocator 214 and transmits the generated UL-MAP to each SS. The memory 216 stores the analysis result of the UL-MAP/history analyzer 213.

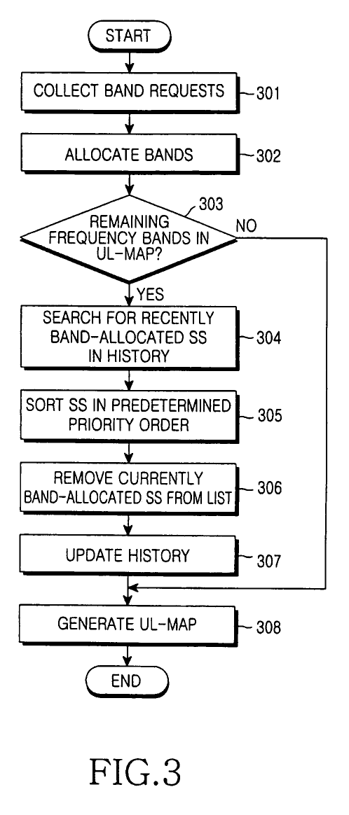

FIG. 3 is a flowchart illustrating an operation of the uplink scheduler according to an exemplary embodiment of the present invention.

Referring to FIG. 3, the band request collector 211 collects frequency band allocation requests from SSs in step 301, and the band allocator 212 allocates frequency bands to the SSs that transmit the frequency band allocation requests, based on the collection result in step 302. In step 303, the UL-MAP/history analyzer 213 checks if there remain frequency bands. If so, the UL-MAP/history analyzer 213 searches for a recently stored history in the memory 216 in step 304 and sorts SSs, which do not presently transmit frequency band allocation requests but have recently performed data upload, in a predetermined priority order in step 305. The band allocator 214 allocates the remaining frequency bands corresponding to the sizes of Bandwidth Request Headers (BRHs) required to transmit frequency band allocation requests to the SSs sorted in the predetermined priority order. The frequency bands allocated to the SSs that do not transmit frequency band allocation requests may be used not only for transmission of the frequency band allocation requests but also for transmission of control information.

The sorting in the predetermined priority order may be performed in the order of most recently uploaded frequency-allocated SS. In this case, the SSs may be sorted in descending order of allocated frequency band size. However, a criterion for the predetermined priority order may be changed arbitrarily by the BS without being limited to the above-described example.

In step 306, the SSs that are allocated frequency bands after requesting frequency band allocation are removed from a list. In step 307, a history stored in the memory 216 is updated. In step 308, the UL-MAP generator 215 finally generates a UL-MAP according to the frequency band allocation and transmits the UL-MAP to the SSs.

As is apparent from the foregoing description, according to the present invention, when there remain non-allocated frequency bands in a UL-MAP, even an SS that is not allocated a frequency band and thus cannot send a frequency band allocation request can transmit the frequency band allocation request without overhead. In particular, it is possible to effectively reduce delay time caused by a frequency band allocation request for a Best Effort (BE) service that cannot be allocated an upload frequency band at all times due to polling.

For example, in the case of transmission of a single frame in a WiBro system, according to a conventional technique, an SS selects a ranging code allocated for a frequency band allocation request, and a BS senses the selected ranging code and allocates an allocation Information Element (IE) to a UL-MAP. The SS then checks a code of a Code Division Multiple Access (CDMA) allocation IE of the UL-MAP. When the checked code is the same as the ranging code, the SS transmits a frequency band allocation request header to an allocated uplink region like the CDMA allocation IE, and the BS allocates a frequency band for uplink data transmission to the SS according to the transmitted frequency band allocation request. The SS transmits data to the BS in the allocated frequency band.

However, according to an exemplary embodiment of the present invention, since a frequency band for transmission of a frequency band allocation request header has already been allocated to the SS, the SS does not have to perform ranging for a frequency band allocation request. Thus, the SS transmits the frequency band allocation request for data transmission immediately upon generation of uplink data and transmits the generated data to the BS in the allocated frequency band. Therefore, an initial delay time reduction of 30 ms or more can be achieved compared to the conventional technique.

According to the present invention, when there remain non-allocated frequency bands in the UL-MAP, even an SS that cannot send a frequency band allocation request can transmit the frequency band allocation request without overhead, thereby reducing initial delay time.

While the invention has been shown and described with reference to a certain exemplary embodiment thereof, it will be understood by those skilled in the art that various changes in form and details may be made therein without departing from the spirit and scope of the invention as defined by the appended claims.

What is claimed is:

1. An uplink scheduling method for a Base Station (BS) in a communication system where each Subscriber Station (SS) is allocated a frequency band by the BS to transmit data, the uplink scheduling method comprising:
collecting frequency band allocation requests from first SSs and allocating frequency bands to the first SSs that transmit the frequency band allocation requests to the BS according to the collection result;
checking if there remain frequency bands that are not allocated to the first SSs from among total frequency bands;
when there remain the non-allocated frequency bands, allocating at least one of the remaining frequency bands to second SSs that do not transmit the frequency band allocation requests to the BS; and
transmitting information of the frequency band allocation to the first SSs and the second SSs.

2. The uplink scheduling method of claim 1, wherein the frequency band allocation to the second SSs comprises allocating the remaining frequency bands to the second SSs in a predetermined priority order by referring to history information indicating a history of the frequency band allocation to the first SSs.

3. The uplink scheduling method of claim 2, wherein the history information contains information of SSs that have recently performed data upload and information of sizes of frequency bands allocated to the SSs.

4. The uplink scheduling method of claim 1, wherein the frequency band allocation to the second SSs comprises allocating the remaining frequency bands to the second SSs corresponding to sizes of headers required to transmit the frequency band allocation requests.

5. The uplink scheduling method of claim 1, further comprising updating history information indicating a history of the frequency band allocation to the first SSs after the frequency band allocation to the second SSs.

6. A Base Station (BS) device for performing uplink scheduling in a communication system where each Subscriber Station (SS) is allocated a frequency band by a BS to transmit data, the BS device comprising:
a frequency band request collector for collecting frequency band allocation requests from first SSs;
a first frequency band allocator for allocating frequency bands to the first SSs that transmit the frequency band allocation requests to the BS according to the collection result of the frequency band request collector;
a second frequency band allocator for allocating at least one of non-allocated frequency bands, which remain after the frequency band allocation, to second SSs that do not transmit the frequency band allocation requests to the BS; and
a MAP generator for generating information of the frequency band allocation of the first frequency band allocator and information of the frequency band allocation of the second frequency band allocator as a MAP and transmitting the generated MAP to the first SSs and the second SSs.

7. The BS device of claim 6, further comprising a history analyzer for analyzing the information of the frequency band allocation, which is transmitted from the first frequency band allocator, and history information indicating a history of the frequency band allocation to the first SSs,
wherein the second frequency band allocator allocates the remaining frequency bands to the second SSs in a predetermined priority order.

8. The BS device of claim 7, wherein the history information contains information of SSs that have recently performed data upload and information of sizes of frequency bands allocated to the SSs.

9. The BS device of claim 6, wherein the second frequency band allocator allocates the remaining frequency bands to the second SSs corresponding to sizes of headers required to transmit the frequency band allocation requests.

10. The BS device of claim 6, further comprising a memory for storing the history information.
